(19) United States
(12) Patent Application Publication
(10) Pub. No.: US 2013/0188686 A1
(43) Pub. Date: Jul. 25, 2013

(54) METHODS AND APPARATUSES FOR PROVIDING AN ADAPTIVE REDUCED RESOLUTION UPDATE MODE

(71) Applicant: MAGNUM SEMICONDUCTOR, INC., Milpitas, CA (US)

(72) Inventor: Alexandros Tourapis, Milpitas, CA (US)

(73) Assignee: MAGNUM SEMICONDUCTOR, INC., Milpitas, CA (US)

(21) Appl. No.: 13/743,091

(22) Filed: Jan. 16, 2013

Related U.S. Application Data
(60) Provisional application No. 61/588,613, filed on Jan. 19, 2012.

(51) Int. Cl. H04N 7/26

(52) U.S. Cl. CPC H04N 19/00139
USPC 375/240.02

(57) ABSTRACT

Methods and apparatuses for applying adaptive reduced resolution update (RRU) processing are disclosed herein. An apparatus may include an encoder configured to receive a video signal and selectively downsample a first component of the video signal in accordance with a first RRU coding mode and a second component of the video signal in accordance with a second RRU coding mode, based on respective types of the first and second components of the video signal. An apparatus may include a decoder configured to receive an encoded bitstream and provide a recovered residual based on the encoded bitstream. The decoder may be configured to selectively upsample a first component of the recovered residual in accordance with a first RRU mode and to selectively upsample a second component of the recovered residual in accordance with a second RRU mode to provide a reconstructed signal based on signaling mechanisms of the encoded bitstream.

### CROSS-REFERENCE

This application claims priority to U.S. Provisional Application No. 61/588,613 filed Jan. 19, 2012, which application is incorporated herein by reference, in its entirety, for any purpose.

### TECHNICAL FIELD

Embodiments of the disclosed invention relate generally to video encoding and/or decoding, and more particularly, in one or more of the illustrated embodiments, to reduced resolution coding.

### BACKGROUND

As video coding standards have evolved, various algorithms and features have been used in an attempt to increase data compression while minimizing the reduction in subjective and/or objective quality. For example, the Reduced-Resolution Update mode introduced in the ITU-T video coding standard H.263 was developed to enable increased coding efficiency while maintaining sufficient subjective quality. Although the syntax of a bitstream encoded in this mode is essentially identical to a bitstream coded in full resolution, the H.263 standard differed in its use of residuals and its addition to the prediction signal after motion compensation or intra prediction. For example, an image in this mode would include one-fourth the number of macroblocks compared to a full resolution coded picture, and motion vector data were associated with block sizes of 32×32 and 16×16 of the full resolution picture instead of 16×16 and 8×8, respectively. As DCT and texture data are associated with 8×8 blocks of a reduced resolution image, an upsampling scheme must be used in order to generate the final full resolution representation.

Although this process significantly reduced objective quality, loss was compensated for as the number of bits that need to be encoded was reduced due to the fewer number (by 4) of modes, motion data, and residuals. In comparison to objective quality, subjective quality was far less impaired as a result of this data reduction.

### BRIEF DESCRIPTION OF THE DRAWINGS

FIG. 1 is a block diagram of an encoder according to an embodiment of the invention.

FIG. 2 is a block diagram of an encoder according to an embodiment of the invention.

FIG. 3 is a flowchart of a process for encoding a sequence of a video stream according to an embodiment of the invention.

FIG. 4 is a flowchart of a process for analyzing and encoding regions according to an embodiment of the invention.

FIG. 5 is a schematic diagram of an example assignment of frames to different RRU coding modes according to an embodiment of the invention

FIG. 6 is a block diagram of a macroblock encoded with various RRU coding modes according to an embodiment of the invention.

FIG. 7a is a schematic diagram of an upsampling scheme for block boundaries according to an embodiment of the invention.

FIG. 7b is a schematic diagram of an upsampling scheme for inner positions according to an embodiment of the invention.

FIG. 8 is a schematic diagram of a decoder according to an embodiment of the invention.

FIG. 9 is a schematic illustration of a media delivery system according to an embodiment of the invention.

FIG. 10 is a schematic illustration of a video distribution system that may make use of encoders described herein.

### DETAILED DESCRIPTION

Methods and apparatuses for providing an adaptive reduced resolution update (RRU) mode are described herein. In at least one embodiment, in accordance with the RRU mode, one or more components (e.g., color components) of a video signal may be selectively downsampled. Certain details are set forth below to provide a sufficient understanding of embodiments of the invention. However, it will be clear to one having skill in the art that embodiments of the invention may be practiced without these particular details, or with additional or different details. Moreover, the particular embodiments of the present invention described herein are provided by way of example and should not be used to limit the scope of the invention to these particular embodiments. In other instances, well-known video components, encoder or decoder components, circuits, control signals, timing protocols, and software operations have not been shown in detail in order to avoid unnecessarily obscuring the invention.

Embodiments of the invention are directed to downsampling. Downsampling is generally a process where resolution, for instance of an image, may be reduced by averaging neighboring samples (e.g., pixels or pixel components). In many cases, averages may be weighted and vary based on the location of the samples relative to an edge or corner. Resolution may also be reduced using subsampling. Subsampling is generally a process where samples may be removed, for instance from an image, such that only a fraction of the original samples remain. Chrominance components of an image with a 4:4:4 sampling rate, for example, may be subsampled to a 4:2:0 resolution by reducing the number of chrominance samples by one-half both vertically and horizontally. While reference is made herein to downsampling of components and/or residuals, it will be appreciated by those having ordinary skill in the art that either downsampling or subsampling may be applied to any of the embodiments described herein.

Embodiments of the invention include methods and apparatuses for providing an RRU coding mode. RRU coding generally refers to a mechanism by which residuals generated from a video signal may be downsampled before being encoded into an encoded bitstream, while prediction (e.g., motion prediction) may still be performed using a full resolution reference. This may, for example, reduce the number of macroblocks or coding units encoded in the bitstream and thereby reduce the bit rate of the bitstream. While RRU coding is generally directed to downsampling residuals, reference is made herein to downsampling particular components of a video signal. This is intended in some examples to encompass a downsampling of any portion of a video signal corresponding to a particular component, including any residuals generated therefrom.

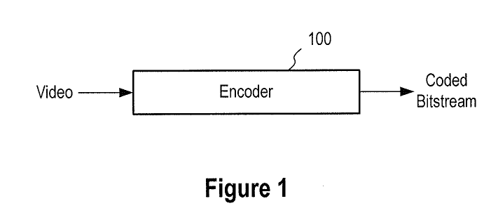

FIG. 1 is a block diagram of an encoder 100 according to an embodiment of the invention. The encoder 100 may include one or more logic circuits, control logic, logic gates, processors, memory, and/or any combination or sub-combination of the same, and may encode and/or compress a video signal using one or more encoding techniques, examples of which will be described further below. The encoder 100 may encode, for example, a variable bit rate signal and/or a constant bit rate signal, and generally may operate at a fixed rate to output a bitstream that may be generated in a rate-independent manner. The encoder 100 may be implemented in any of a variety of devices employing video encoding, including, but not limited to, televisions, broadcast systems, mobile devices, and both laptop and desktop computers.

In at least one embodiment, the encoder 100 may include an entropy encoder, such as a variable-length coding encoder (e.g., Huffman encoder, run-length encoder, or CAVLC encoder), and/or may encode data, for instance, at a macroblock level. Each macroblock may be encoded in intra-coded mode, inter-coded mode, bidirectionally, or in any combination or subcombination of the same.

In an example operation, the encoder 100 may receive and encode a video signal that, in one embodiment, may comprise video data (e.g., frames). The encoder 100 may encode the video signal partially or fully in accordance with one or more encoding standards, such as MPEG-2, MPEG-4, H.263, H.264, H.HEVC, or any combination thereof, to provide an encoded bitstream. The encoded bitstream may be provided to a data bus and/or to a device, such as a decoder or transcoder (not shown).

As will be explained in more detail below, the encoder 100 may operate in an RRU coding mode and accordingly may selectively downsample one or more components of a video signal. In one embodiment, components may be selectively downsampled based on respective types (e.g., luminance, blue-difference chrominance, red-difference chrominance) of components and/or the importance of the component in a particular video, scene, image, macroblock, or any other coding units. By way of example, chrominance components of a video signal may be downsampled in portions of the signal wherein one or more sequences includes a relatively high amount motion and/or blue pixels. Downsampling in this manner may be applied at any syntax level, including, but not limited to, sequence, picture, slice, and macroblock syntax levels.

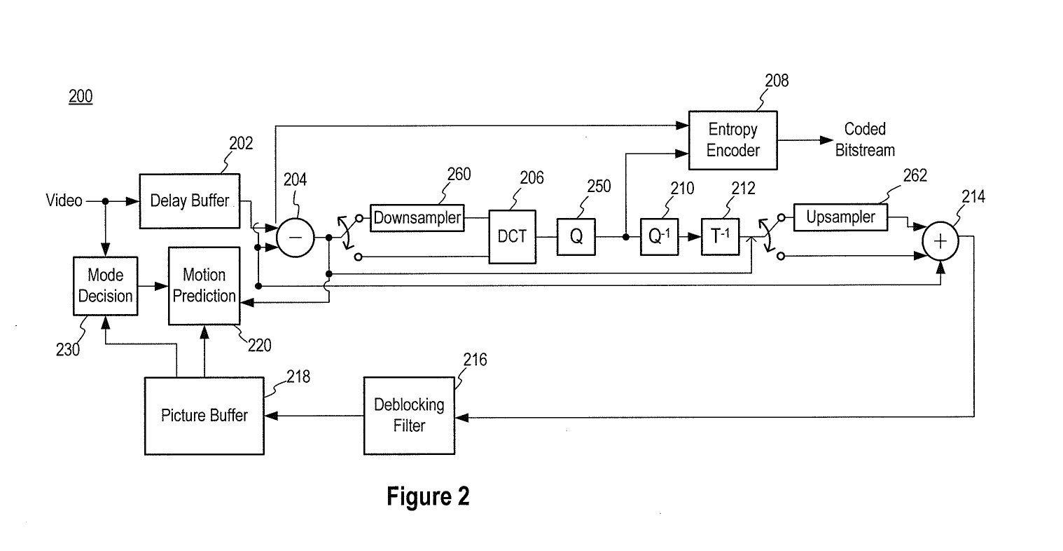

FIG. 2 is a schematic block diagram of an encoder 200 according to an embodiment of the invention. The encoder 200 may be used to implement, at least in part, the encoder 100 of FIG. 1, and may further be partially or fully compliant with the H.264 coding standard. In some embodiments, the encoder 200 may additionally or alternatively be partially or fully compliant with one or more other coding standards known in the art, such as the H.263 coding standard. The encoder 200 may include a mode decision block 230, a prediction block 220, a delay buffer 202, a transform 206, a downsampler 260, a quantization block 250, an entropy encoder 208, an inverse quantization block 210, an inverse transform block 212, an upsampler 262, an adder 214, a deblocking filter 216, and a picture buffer 218.

The mode decision block 230 may determine an appropriate operating modes based, at least in part, on the incoming base band video signal and decoded picture buffer signal, described further below, and/or may determine appropriate operating mode on a per frame and/or macroblock basis. Additionally, the mode decision block 230 may employ motion and/or disparity estimation of the video signal. The mode decision may include macroblock type, intra modes, inter modes, syntax elements (e.g., motion vectors), and quantization parameters.

When the encoder 200 operates in the RRU mode, the mode decision block 230 may further analyze the video signal to determine whether one or more components of the video signal should be downsampled. That is, the mode decision block 230 may analyze the video signal and provide a signal including one or more RRU coding modes, in the video signal. An RRU coding mode may indicate the manner in which a video signal may be downsampled and may be applied to individual components and/or any syntax level of the video signal. As an example, RRU coding modes may indicate that less than all components of a sequence may be downsampled, that all components be downsampled, or that all components be encoded at full resolution. In some examples, residuals corresponding to components may be selectively downsampled using RRU coding modes signaled in the video signal by the mode decision block 230. Accordingly, residuals to be encoded at downsampled resolutions may be provided to the downsampler 260 and residuals to be encoded at full resolution may be provided directly to the transform 206.

The output of the mode decision block 230 may be utilized by the prediction block 220 to generate a predictor in accordance with a coding standard, such as the H.264 coding standard, and/or other prediction methodologies, and in at least one embodiment, the prediction block 220 may generate the predictor based on a full resolution reference. The predictor may be subtracted from a delayed version of the video signal at the subtractor 204. Using the delayed version of the video signal may provide time for the mode decision block 230 to act. The output of the subtractor 204 may be a residual, e.g. the difference between a block and a predicted block, and the residual may be provided to the downsampler 260 or the DCT transform 208.

As described, if a signal for a component includes an RRU coding mode indicating that a component is to be downsampled, any residuals corresponding to the component may be provided to the downsampler 260. The downsampler 260 may downsample each residual in accordance with the RRU coding mode, or and/or may reduce the resolution based on a fixed upsampling process. That is, and as will be explained below, reconstructed reduced resolution residuals may be upsampled by an upsampler 262. In some embodiments, this upsampling may use an upsampling scheme that is a fixed, normative conversion, and based on the scheme, multiple downsampling filters may be applied to a residual by the downsampler 260. A downsampled residual best satisfying a particular criteria may be selected and provided to the transform 206. For example, the downsampler 260 may provide the downsampled residual producing the closest representation of the original signal (e.g., based on sum of absolute error computation) after applying the upsampling scheme.

The transform 206 may receive the full resolution residual from the subtractor 204 or the reduced resolution residual from the downsampler 260, and perform a transform, such as a discrete cosine transform (DCT), to transform the residual to the frequency domain. As a result, the transform 206 may provide a coefficient block that may, for instance, correspond to spectral components of data in the video signal. The quantization block 250 may receive the coefficient block and quantize the coefficients of the coefficient block to produce a quantized coefficient block. The quantization employed by the quantization block 250 may be lossy, but may adjust and/or optimize one or more coefficients of the quantized coefficient block based, for example, on a Lagrangian cost function.

In turn, the entropy encoder 208 may encode the quantized coefficient block to provide an encoded bitstream. The encoded bitstream may include, for instance, one or more signals provided by the mode decision 230. In one embodiment, only signals for particular syntax levels may be included in the bitstream. As an example, RRU coding modes may be included in the bitstream only for blocks, macroblocks, frames and/or pictures. The entropy encoder 208 may be any entropy encoder known by those having ordinary skill in the art, such as a variable length coding (VLC) encoder. The quantized coefficient block may also be inverse scaled and quantized by the inverse quantization block 210. The inverse scaled and quantized coefficients may be inverse transformed by the inverse transform block 212 to produce a reconstructed residual.

The upsampler 262 may selectively upsample one or more residuals. For example, if a residual was downsampled by the downsampler 260, the corresponding reconstructed residual may be upsampled by the upsampler 262. In some embodiments, the upsampler 262 may upsample the reconstructed residual in a fixed manner, or may upsample based on the downsampling of the downsampler 260, as described above. The upsampler 262 may receive signals provided in the video signal and upsample the reconstructed residual such that the downsampling is reversed. The upsampler 262 may comprise any interpolation filter known in the art, now or in the future, including, but not limited to, bilinear, bicubic, and lanczos interpolation filters.

The reconstructed residual may be added to the predictor at the adder 214 to produce reconstructed video, which may in turn be deblocked by the deblocking filter 216, written to the picture buffer 218 for use in future frames, and fed back to the mode decision block 230 for further in-macroblock intra prediction or other mode decision methodologies.

As discussed, the encoder 200 may operate in accordance with any known video coding standard, including the H.264 coding standard. Thus, because various video coding standards employ motion prediction and/or compensation, the encoder 200 may further include a feedback loop that includes an inverse quantization block 210, an inverse transform 212, an upsampler 262, a reconstruction adder 214, and a deblocking filter 216. These elements may mirror elements included in a decoder that may reverse, at least in part, the encoding process performed by the encoder 200. Additionally, the feedback loop of the encoder may include a prediction block 220 and a picture buffer 218.

In an example operation of the encoder 200, a video signal (e.g. a base band video signal) may be provided to the encoder 200. The video signal may be provided to the delay buffer 202 and the mode decision block 230. The mode decision block 230 may analyze the video signal, thereby selectively downsample one or more components of the video signal. The mode decision 230 may provide a signal indicating that one or more components are to be downsampled using one or more RRU coding modes included in the signal, and may determine whether to downsample a component based on the type of the component, and/or the importance of the component to a particular coding unit (e.g., macroblock, scene, image). By way of example, chrominance components may be signaled with a first RRU coding mode (e.g., downsample from 4:4:4 to 4:2:0) and a luminance component may be signaled with a second RRU coding mode (e.g., no downsampling).

The subtractor 204 may receive the video signal from the delay buffer 202 and may subtract a motion prediction signal from the video signal to generate a residual. The residual may be provided either to the transform 206 or the downsampler 260 based signaling of the mode decision block 230. The residual (e.g., full resolution residual or downsampled residual) may be provided to the transform 206 and processed using a forward transform, such as a DCT. As described, the transform 206 may generate a coefficient block that may be provided to the quantization block 250, and the quantization block 250 may quantize and/or optimize the coefficient block. The entropy encoder may encode the quantized coefficient block and corresponding syntax elements, including any signals provided by the mode decision block 230, to provide an encoded bitstream.

The quantized coefficient block may further be provided to the feedback loop of the encoder 200. That is, the quantized coefficient block may be inverse quantized, inverse transformed, upsampled (e.g., if previously downsampled), and added to the motion prediction signal by the inverse quantization block 210, the inverse transform 212, the upsampler 262, and the reconstruction adder 214, respectively, to produce a reconstructed video signal. The deblocking filter 216 may receive the reconstructed video signal, and the picture buffer 218 may receive a filtered video signal from the deblocking filter 216. In one embodiment, the level of deblocking employed by the deblocking filter 216 may be based on signals by the mode decision 230 for respective components. Using the filtered video signals, the prediction block 220 may provide a motion prediction signal to the adder 204.

As known, a deblocking filter, such as the deblocking filter 216, may smooth edges of a decoded video signal. Although the encoder 200 is illustrated as including a deblocking filter 216, in at least one embodiment in which the encoder 200 may encode in accordance with the HEVC coding standard, the deblocking filter 216 may include a deblocking filter, a sample adaptive offset (SAO) filter, and an adaptive loop filter (AFL). These filters may use any encoding parameters known in the art, now or in the future, and further may filter decoded signals based on RRU coding modes signaled in the video signal and/or bitstream. In some embodiments, the encoding parameters may additionally or alternatively be predetermined and/or signaled in the video stream. As an example, a deblocking strength of +2 and a SAO offset of +1 may be used for residuals corresponding to RRU coded components.

Moreover, while the encoder 200 illustrates transforming downsampled residuals and employing motion prediction with full resolution references, in some embodiments, both prediction and residual coding may be employed using reduced resolution references. In one embodiment, this may be implemented by downscaling the predictor and upscaling the reconstructed video signal before, or after, any filtering processes.

Accordingly, the encoder 200 of FIG. 2 may operate in an RRU mode to provide a coded bitstream having one or more downsampled components at one or more syntax levels. The encoder 200 may be operated in semiconductor technology, and may be implemented in hardware, software, or combinations thereof. In some examples, the encoder 200 may be implemented in hardware with the exception of the mode decision block 230 that may be implemented in software. In other examples, other blocks may also be implemented in software, however software implementations in some cases may not achieve real-time operation.

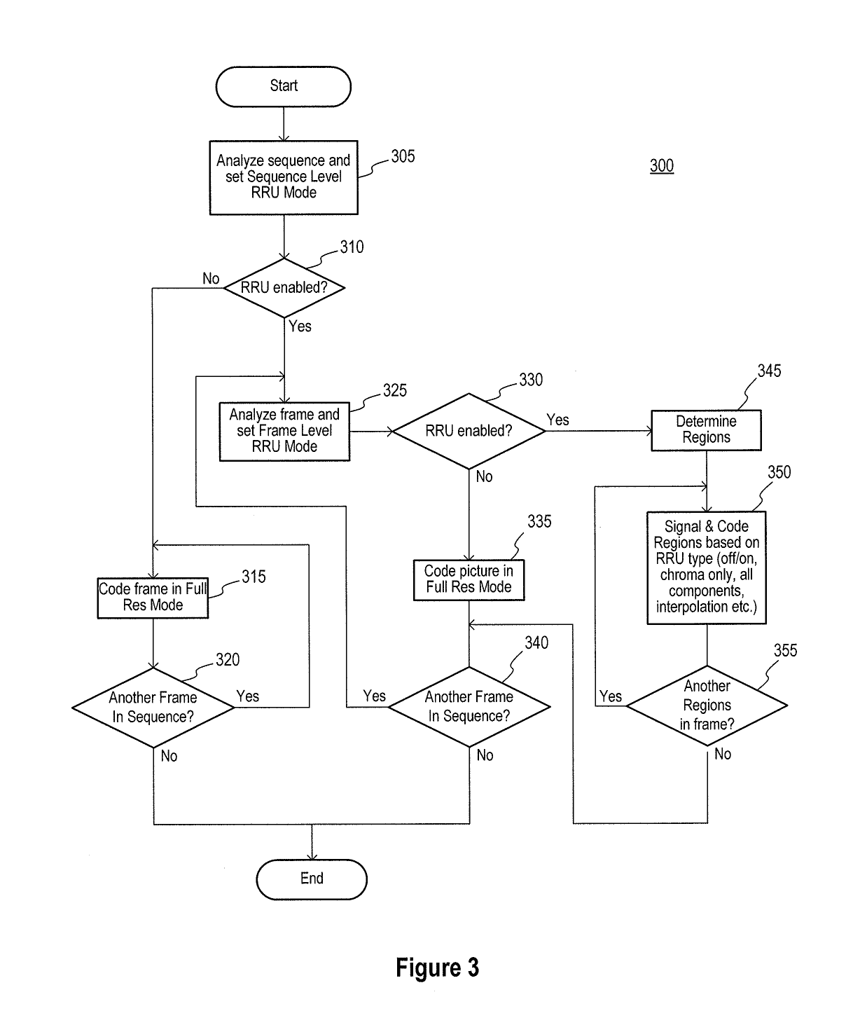

FIG. 3 is a flowchart of a process 300 for encoding a sequence of a video stream according to an embodiment of the invention. The process 300 may be implemented using any of the encoders described herein, including the encoder 100 of FIG. 1 and the encoder 200 of FIG. 2. In particular, while implementation of the process 300 will be described with the mode decision block 230 of FIG. 2, it will be appreciated by those having ordinary skill in the art that any number of other elements of the encoder 200 of FIG. 2 may be used to implement one or more steps of the process 300.

At a step 305, a sequence of a video signal may be analyzed, for instance, by the mode decision block 230, and based on the analysis, a sequence level RRU mode may be enabled. Whether the sequence level RRU mode is enabled may be based, for instance, on various metrics of the sequence, including, but not limited to the content (e.g., movie, live broadcast, etc.), motion, and/or sampling rate of each component of the sequence.

At a step 310, the mode decision block 230 may further determine whether the sequence level RRU mode processing is enabled. If the sequence level RRU mode processing is disabled, a first frame of the sequence may be encoded at full resolution at a step 315. Encoding a frame at full resolution may, for example, include providing residuals for all components of the frame from the subtractor 204 to the DCT transform 206, thereby bypassing the downsampler 260. In at least one embodiment, encoding a frame at full resolution may further include providing one or more signals including an RRU coding mode indicating that the frame is to be encoded at full resolution. If any unencoded frames remain in the sequence at a step 320, the next frame of the sequence may be encoded at full resolution at the step 315. Steps 315 and 320 may be iteratively repeated until all frames of the sequence have been encoded at full resolution.

If instead the sequence level RRU mode is enabled, the process 300 may analyze a first frame of the sequence at a step 325. In accordance with this analysis, a frame level RRU mode may be enabled. Similar to the determination for the sequence level RRU mode, the mode decision block 230 may determine whether to enable the frame level RRU mode, for instance, based on various metrics of the frame of the sequence. At a step 330, the mode decision block 230 may determine whether the frame level RRU mode has been enabled, and if the frame level RRU mode is disabled, the frame may be encoded in full resolution at a step 335. If any unencoded frames remain in the sequence, at a step 340, the next frame may be analyzed by the mode decision block 230 to determine if the frame level RRU mode should be enabled.

If the frame level RRU mode is enabled for a frame, regions, such as macroblocks or groups of macroblocks, of the frame may be identified at a step 345. In one embodiment, regions may be identified by the mode decision block 230. At a step 350, the first macroblock may be analyzed, for example, by the mode decision block 230 to determine whether any components of the macroblock should be downsampled, and if so, in what manner. As described below, this determination may be based on respective types of components, the proximity of the macroblock to an edge, testing code performance (e.g., rate-distortion cost), spatio-temporal analysis, or a combination thereof. As an example, responsive to the macroblock having an edge, the mode decision block 230 may provide a signal corresponding to one or more of the chrominance components of the analyzed macroblock with a first RRU coding mode (e.g., downsample to 4:2:0), and signal the luminance component of the analyzed macroblock with a second RRU coding mode (e.g., no downsampling).

Signals provided in this manner may be syntax elements including one or more RRU coding modes and further may be applied at any syntax level. For example, a signal may include an RRU coding mode indicating that a component of a sequence is to be downsampled in accordance with the RRU coding mode, or may indicate that a component of a macroblock is to be encoded at full resolution in accordance with the RRU coding mode. Once any downsampling has been employed as a result of signaling by the mode decision block 230, residuals (e.g., downsampled or full resolution) for each component may be encoded, for instance, by the entropy encoder 208, and provided in a bitstream. As described, signals may be encoded in the bitstream as well, and in some embodiments, only signals corresponding with particular syntax levels may be encoded in the bitstream. Signals may further include resolutions to which each residual may dynamically switch. In some embodiments, signals may be provided only for downsampled residuals and/or may be provided for residuals encoded at full resolution. Moreover, in some embodiments, a signal may correspond to multiple components. For example, in at least one embodiment, multiple components may be downsampled using a single signal and/or RRU coding mode. At a step 355, if any macroblocks remain in the current frame, the next macroblock may be considered at the step 350.

In some embodiments, signaling may be explicit, for example, by introducing one or more syntax elements in a coding standard, or may be implicit, for example, by associating a signal with an already existing syntax element in a known coding standard, such as HEVC or H.264. Table 1, for example, may include parameters for use with at least one embodiment of the invention. In particular, in a coding standard, such as HEVC, new parameters (e.g., rru_coding_mode) that provide sequence level support of RRU and RRU type designation (e.g., no RRU chrominance only, all components, interpolation filters, etc.) may be used to signal at various levels. Table 1 illustrates example parameters corresponding to sequence level RRU processing.

TABLE 1

| seq_parameter_set_rbsp( ) { | Descriptor |
|---|---|
| profile_idc | u(8) |
| reserved_zero_8bits /* equal to 0 */ | u(8) |
| level_idc | u(8) |
| seq_parameter_set_id | ue(v) |
| max_temporal_layers_minus1 | u(3) |
| pic_width_in_luma_samples | u(16) |
| pic_height_in_luma_samples | u(16) |
| rru_coding_mode | ue(v) |
| bit_depth_luma_minus8 | ue(v) |
| bit_depth_chroma_minus8 | ue(v) |
| pcm_bit_depth_luma_minus1 | u(4) |
| pcm_bit_depth_chroma_minus1 | u(4) |
| log2_max_frame_num_minus4 | ue(v) |
| pic_order_cnt_type | ue(v) |
| if( pic_order_cnt_type == 0 ) | |
| log2_max_pic_order_cnt_lsb_minus4 | ue(v) |
| else if( pic_order_cnt_type == 1) { | |
| delta_pic_order_always_zero_flag | u(1) |
| offset_for_non_ref_pic | se(v) |
| num_ref_frames_in_pic_order_cnt_cycle | ue(v) |
| .... | |

Table 2 comprises coding flags for use with at least one embodiment of the invention described herein. Coding flags may, for example, be used to reduce overhead at the slice level. If “rru_coding_flag” is not set, for instance, normal coding may be used. Otherwise, additional information may be required at one or more levels to indicate an RRU mode.

TABLE 2

| pic_parameter_set_rbsp( ) { | Descriptor |
|---|---|
| pic_parameter_set_id | ue(v) |
| seq_parameter_set_id | ue(v) |
| entropy_coding_synchro | u(v) |
| cabac_istate_reset_flag | u(1) |
| if( entropy_coding_synchro ) | |
| num_substreams_minus1 | ue(v) |
| num_temporal_layer_switching_point_flags | ue(v) |
| for( i = 0; | |
| i < num_temporal_layer_switching_point_flags; i++ ) | |
| temporal_layer_switching_point_flag[ i ] | u(1) |
| num_ref_idx_l0_default_active_minus1 | ue(v) |
| num_ref_idx_l1_default_active_minus1 | ue(v) |
| pic_init_qp_minus26 /* relative to 26 */ | se(v) |
| constrained_intra_pred_flag | u(1) |
| slice_granularity | u(2) |
| max_cu_qp_delta_depth | ue(v) |
| rru_coding_flag | ue(v) |
| weighted_pred_flag | u(1) |
| weighted_bipred_idc | u(2) |
| tile_info_present_flag | u(1) |
| if( tile_info_present_flag == 1) { | |
| num_tile_columns_minus1 | ue(v) |
| num_tile_rows_minus1 | ue(v) |
| if( num_tile_columns_minus1 != 0 \|\| | |
| num_tile_rows_minus1 != 0) { | |
| tile_boundary_independence_flag | u(1) |
| uniform_spacing_flag | u(1) |
| if( !uniform_spacing_flag ) { | |
| for( i = 0; i < num_tile_columns_minus1; i++ ) | |
| column_width[i] | ue(v) |
| for( i = 0; i < num_tile_rows_minus1; i++ ) | |
| row_height[i] | ue(v) |
| } | |
| } | |
| } | |
| rbsp_trailing_bits( ) | |
| } | |

Table 3 includes example RRU types that may be used with at least one embodiment of the invention described herein. As an example, a table of RRU types may be used at the slice level to associate RRU types with a reference list of indices.

TABLE 3

| slice_header( ) { | Descriptor |
|---|---|
| entropy_slice_flag | u(1) |
| if( !entropy_slice_flag ) { | |
| slice_type | ue(v) |
| pic_parameter_set_id | ue(v) |
| if( sample_adaptive_offset_enabled_flag \|\| | |
| adaptive_loop_filter_enabled_flag ) | |
| aps_id | ue(v) |
| frame_num | u(v) |
| if( IdrPicFlag ) | |
| idr_pic_id | ue(v) |
| if( pic_order_cnt_type == 0 ) | |
| pic_order_cnt_lsb /* | u(v) |
| if( slice_type == P \|\| slice_type == B ) { | |
| num_ref_idx_active_override_flag | u(1) |
| if( num_ref_idx_active_override_flag ) { | |
| num_ref_idx_l0_active_minus1 | ue(v) |
| if( slice_type == B ) | |
| num_ref_idx_l1_active_minus1 | ue(v) |
| } | |
| } | |
| ref_pic_list_modification( ) | |
| ref_pic_list_combination( ) | |
| if( nal_ref_flag ) | |
| dec_ref_pic_marking( ) | |
| } | |
| first_slice_in_pic_flag | u(1) |
| if( first_slice_in_pic_flag == 0 ) | |
| slice_address | u(v) |
| if( !entropy_slice_flag ) { | |
| slice_qp_delta | se(v) |
| inherit_dbl_params_from_APS_flag | u(1) |
| if ( !inherit_dbl_params_from_APS_flag ) { | |
| disable_deblocking_filter_flag | u(1) |
| if ( !disable_deblocking_filter_flag ) { | |
| beta_offset_div2 | se(v) |
| tc_offset_div2 | se(v) |
| } | |
| } | |
| if( slice_type == B ) | |
| collocated_from_l0_flag | u(1) |
| if( adaptive_loop_filter_enabled_flag && | |
| aps_adaptive_loop_filter_flag ) { | |
| byte_align( ) | |
| alf_cu_control_param( ) | |
| byte_align( ) | |
| } | |
| if( ( weighted_pred_flag && slice_type == P) \|\| | |
| ( weighted_bipred_idc == 1 && slice_type == B ) ) | |
| pred_weight_table( ) | |
| if (rru_coding_flag) | |
| rru_coding_table( ) | |
| } | |
| if( slice_type == P \|\| slice_type == B ) | |
| 5_minus_max_num_merge_cand | ue(v) |
| for( i = 0; i < num_substreams_minus1 + 1; i++ ){ | |
| substream_length_mode | u(2) |
| substream_length[i] | u(v) |
| } | |
| } | |

Table 4 includes example coding table syntax according to an embodiment of the invention. As shown, in one embodiment three modes may be supported: RRU off, RRU for all color components, and RRU for chrominance components only. Moreover, one or more interpolators may be signaled.

TABLE 4

| rru_coding_table( ) { | Descriptor |
|---|---|
| for( i = 0; i <= num_ref_idx_l0_active_minus1; i++ ) { | |
| rru_coding_method_l0[i] | ue(v) |
| if( rru_coding_method_l0[i] == 1) { | |
| rru_luma_interpolator_l0[i] | ue(v) |
| rru_cb_interpolator_l0[i] | ue(v) |
| rru_cr_interpolator_l0[i] | ue(v) |
| } | |
| else if( rru_coding_method_l0[i] == 2) { | |
| rru_cb_interpolator_l0[i] | ue(v) |
| rru_cr_interpolator_l0[i] | ue(v) |
| } | |
| } | |
| for( i = 0; i <= num_ref_idx_l1_active_minus1; i++ ) { | |
| rru_coding_method_l1[i] | ue(v) |
| if( rru_coding_method_l1[i] == 1) { | |
| rru_luma_interpolator_l1[i] | ue(v) |
| rru_cb_interpolator_l1[i] | ue(v) |
| rru_cr_interpolator_l1[i] | ue(v) |
| } | |
| else if( rru_coding_method_l1[i] == 2) { | |
| rru_cb_interpolator_l1[i] | ue(v) |
| rru_cr_interpolator_l1[i] | ue(v) |
| } | |
| } | |

In at least one embodiment, a signal may comprise a reference picture index indicator. In H.264, the reference picture index may allow the codec to reference multiple pictures that may have been previously decoded, but may also be used to access other information that may be associated with these references, such as weighting and illumination change parameters. Thus, in at least one embodiment, picture list reordering/modification instructions may be used to assign to different reference indices a same actual reference picture multiple times, but with different weighting parameters in each case. In examples described herein, the use of RRU coding modes and/or the type/method of downsampling may be indicated using different reference indices having different RRU parameters. As an example, it may be desirable for some regions (e.g., areas near edges) to not be downsampled according to RRU coding modes, and for remaining areas to be downsampled according to one or more RRU coding modes for chrominance components only. In addition, it may be desirable to allocate three reference indices, with each one pointing to a same reference, but assigned to respective downsampling methodologies. Signals may be provided and the reference indices assigned in a manner similar to how the weighted prediction information is assigned.

Accordingly, the encoder 200 may implement the process 300 to analyze a video signal at sequence, frame, and/or macroblock levels to determine whether one or more components of a video signal should be downsampled in accordance with an RRU coding mode. In other embodiments, other syntax levels of a video signal may be used. That is, the process 300 may analyze groups of blocks, macroblocks, slices, frames, pictures, sequences and/or groups of pictures (GOP).

With respect to the step 350 of FIG. 3, one or more methodologies may be used for determining whether to downsample one or more components of the video signal. Whether components are downsampled may be based, for example, on rate-distortion costs or spatio-temporal analysis. Distortion costs may be measured using a sum of square differences, sum of absolute errors, and/or Structure Similarity Index (SSIM), or other objective measurements, and rate costs may be measured using estimated bit rates or actual bit rates based, for example, on motion vector and other coding element costs for each possible coding mode.

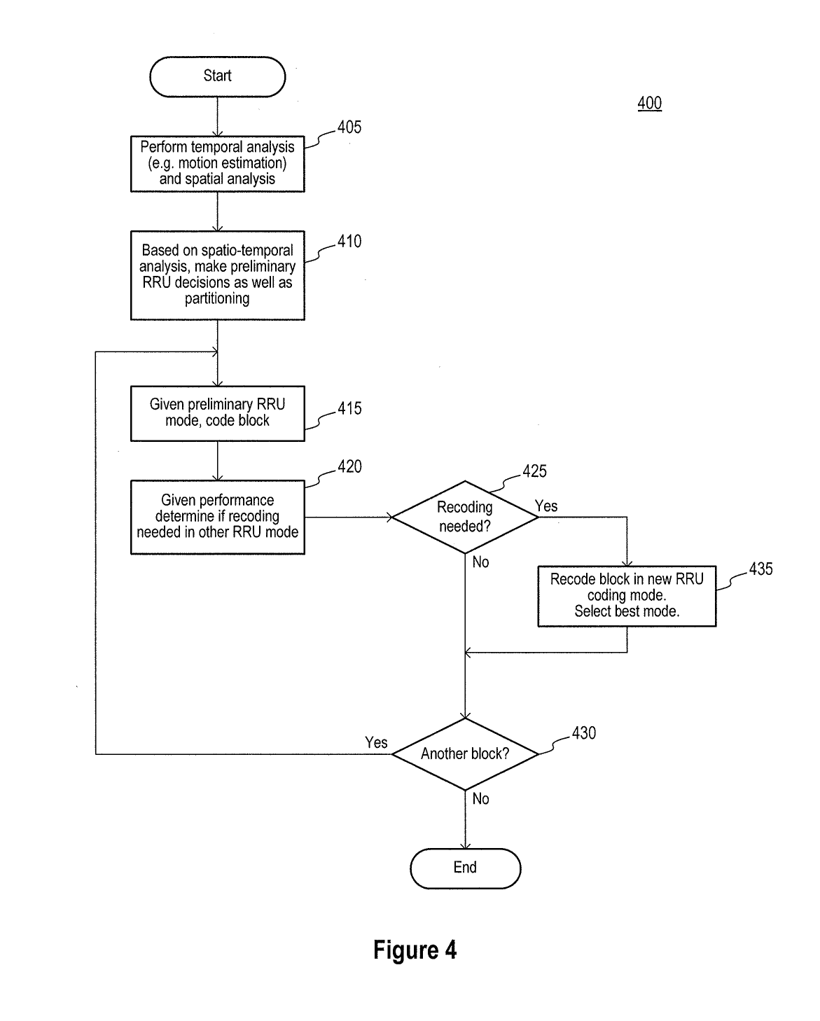

FIG. 4 is a flowchart of a process 400 for analyzing and encoding regions according to an embodiment of the invention. The process 400 may be used to implement the step 350 of FIG. 3. While the process 400 described herein is described with respect to macroblocks of a video signal, it will be appreciated by those having ordinary skill in the art that the process 400 may be applied at any syntax level of a video signal.

At a step 405, spatio-temporal analysis may be performed on a macroblock, for instance, by the mode decision block 230. This analysis may be based, for example, on texture, motion, residual characteristics, AC coefficients, one or more predefined conditions (e.g., relative location in an image), or a combination thereof. Based on the analysis, at a step 410, preliminary RRU coding decisions may be defined for the macroblock. That is, in accordance with one or more coding standards, whether any components of the macroblock should be downsampled may be determined, and if so, in what manner. Additionally, the macroblock may be partitioned, for instance, into a plurality of blocks.

At a step 415, a first block of the macroblock may be coded in accordance with the preliminary RRU decisions, for instance, by the downsampler 260. At a step 420, it may be determined whether the coded block satisfies one or more particular criteria. For example, it may be determined whether the coded block has a bit rate satisfying a particular threshold. If the coded block satisfies the criteria at a step 425, the block may be encoded, for instance, by the entropy encoder 208, and provided in an encoded bitstream. A signal corresponding to the block may also be provided in the encoded bitstream.

If the encoded block does not satisfy the particular criteria at the step 425, fallback RRU coding decisions may be used to encode the block at a step 435, and the RRU decisions that best satisfies the criteria may be selected for the current block. In at least one embodiment, the fallback RRU coding decisions may include reducing the resolution of the block to a lower resolution than that of the preliminary RRU coding decisions. Other RRU coding decisions may also be used, such as RRU coding decisions increasing the resolution of the block to a higher resolution than that of the preliminary RRU coding decisions. Any remaining blocks may be iteratively encoded using steps 415, 420, 425, and 430 until each block of the macroblock has been considered.

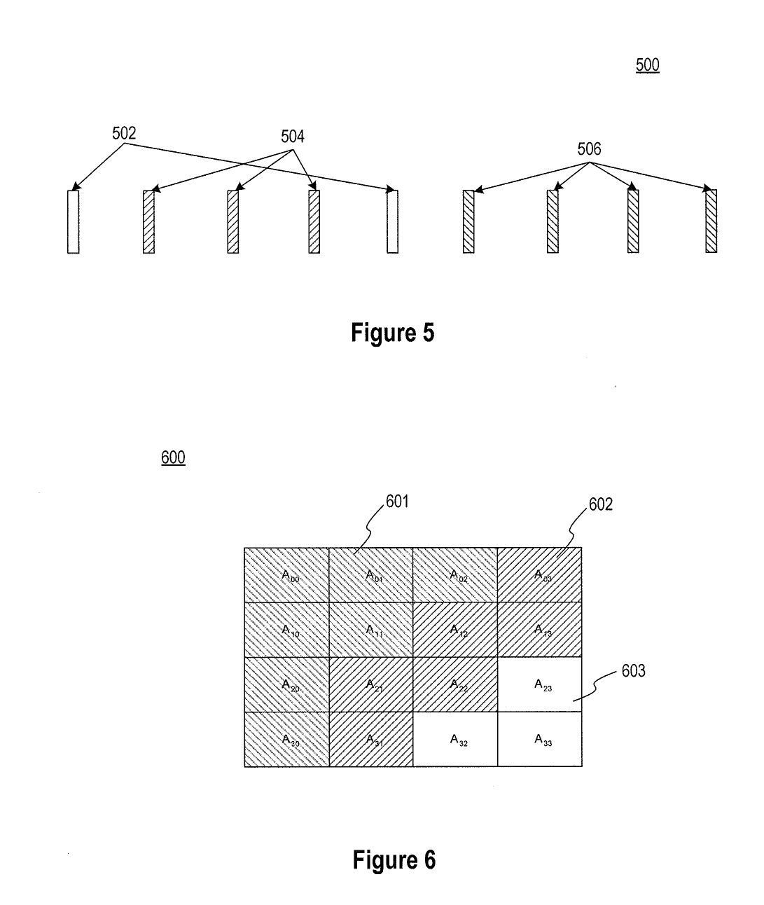

FIG. 5 is a schematic diagram 500 of an example assignment of different RRU coding modes to frames according to an embodiment of the invention. Frames 502, for instance, may correspond to an RRU coding mode where all components are encoded at full resolution. Frames 504 may correspond to an RRU coding mode where blue-difference chrominance and red-difference chrominance components are encoded at reduced resolutions. Frames 506 may correspond to an RRU coding mode where all components are encoded at reduced resolutions.

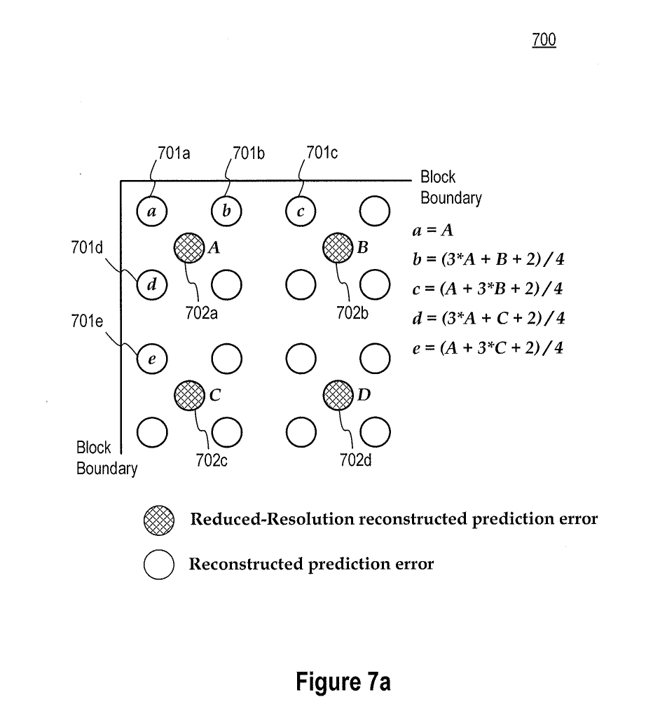

FIG. 6 is a block diagram of a macroblock 600 coded with various RRU coding modes according to an embodiment of the invention. The macroblock 600 may comprise a plurality of blocks corresponding to one of three areas 601, 602, 603. Blocks corresponding to area 601 correspond to an RRU coding mode in which blue-difference and red-difference chrominance components have been coded at reduced resolutions (e.g., downsampled). Blocks corresponding to area 602 to an RRU coding mode in which all components have been coded at reduced resolutions. Blocks corresponding to area 603 correspond to an RRU coding mode in which no components have been encoded at reduced resolutions. In other examples, different blocks may be use any combination of reduced resolutions for respective components.

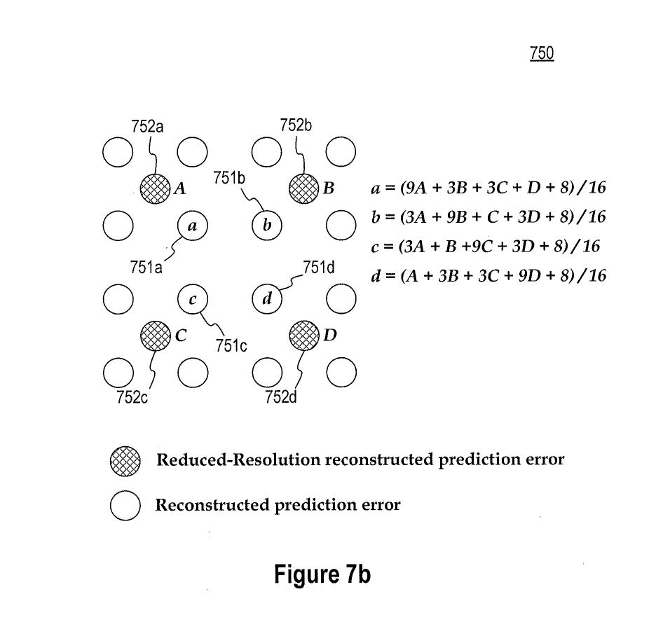

FIG. 7a is a schematic diagram of an upsampling scheme 700 for block boundaries according to an embodiment of the invention. As shown, the upsampling scheme 700 may use downsample pixels 702 to calculate respective values for each of the upsample pixels 701. Moreover, each of the upsample pixels 701 may correspond to a respective formula by which value for the pixels 701 may be calculated during an upsampling process. For example, pixel 701b corresponds to a formula wherein the value of the pixel may be determined by b=(3*A+B+2)/4, where A and B correspond to respective values of downsample pixels 702a and 702b. Other pixel value formulations for upsampling may be used in other examples.

FIG. 7b is a schematic diagram 750 of an upsampling scheme 750 for inner positions according to an embodiment of the invention. As shown, the upsampling scheme 750 uses downsample pixels 752 to calculate values for each of the upsample pixels 751. Similar to the pixels 701 of FIG. 7a, values for each of the upsample pixels 751 may be determined with a respective formula using values of downsampled pixels 752.

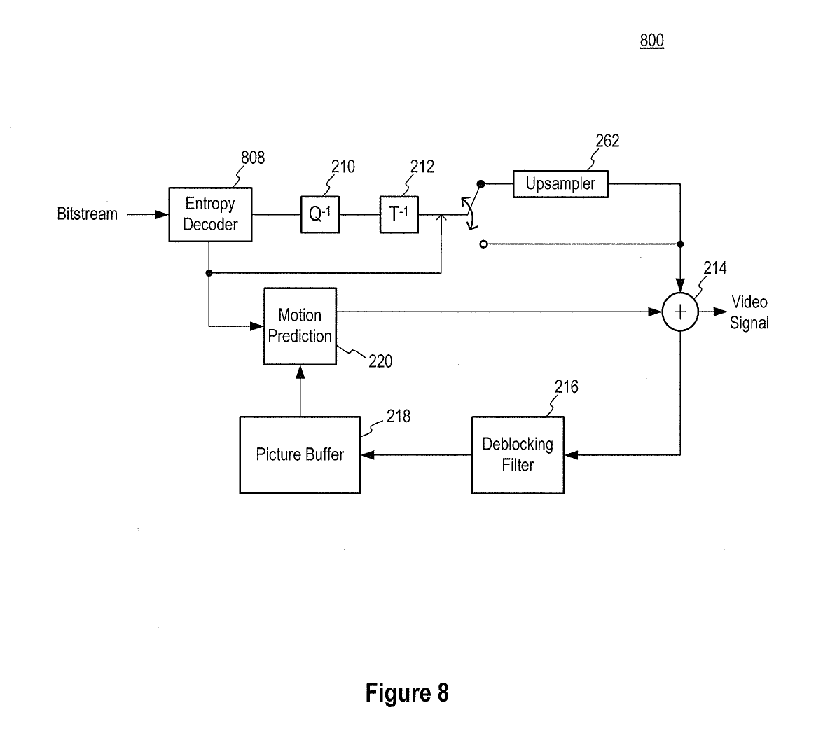

FIG. 8 is a schematic diagram of a decoder 800 according to an embodiment of the invention. The decoder 800 may include one or more logic circuits, control logic, logic gates, processors, memory, and/or any combination or sub-combination of the same, and may decode and/or decompress a video signal using one or more decoding techniques known in the art, now or in the future. The decoder 800 may decode, for example, a bitstream (e.g., encoded bitstream), provided by an encoder, such as the encoder 100 of FIG. 1. The decoder 800 may be implemented in any of a variety of devices employing video encoding, including but not limited to, televisions, broadcast systems, mobile devices, and both laptop and desktop computers. The decoder 800 may further be partially or fully compliant with the H.264 coding standard, and in some embodiments, may additionally or alternatively be partially or fully compliant with one or more other coding standards known in the art, such as the H.263 and HEVC coding standards.

The decoder 800 includes elements that have been previously described with respect to the encoder 200 of FIG. 2. Those elements have been identified in FIG. 8 using the same reference numbers used in FIG. 2 and operation of the common elements is as previously described. Consequently, a detailed description of the operation of these elements will not be repeated in the interest of brevity.

The decoder 800 may include an entropy decoder 808 that may decode an encoded bitstream. After decoding the encoded bitstream, the resulting quantized coefficient blocks may be inverse quantized and inverse transformed, as previously described, and each recovered residual may be provided to the upsampler 262 or to the adder 214. In at least one embodiment, the entropy decoder 808 may determine whether a residual may be provided to the upsampler 262 or to the adder 214. The entropy decoder 808 may make this determination, for instance, based on signaling mechanisms and/or other data included in the encoded bitstream. Accordingly, downsampled residuals may be upsampled and/or provided to the adder 214 to provide a reconstructed video signal.

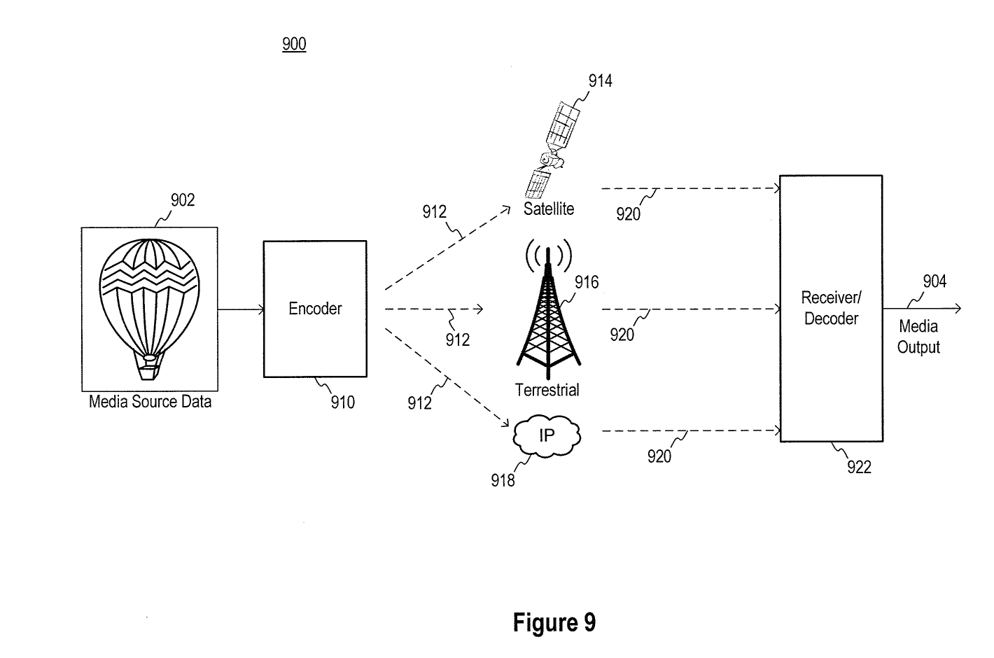

FIG. 9 is a schematic illustration of a media delivery system in accordance with embodiments of the present invention. The media delivery system 900 may provide a mechanism for delivering a media source 902 to one or more of a variety of media output(s) 904. Although only one media source 902 and media output 904 are illustrated in FIG. 9, it is to be understood that any number may be used, and examples of the present invention may be used to broadcast and/or otherwise deliver media content to any number of media outputs.

The media source data 902 may be any source of media content, including but not limited to, video, audio, data, or combinations thereof. The media source data 902 may be, for example, audio and/or video data that may be captured using a camera, microphone, and/or other capturing devices, or may be generated or provided by a processing device. Media source data 902 may be analog or digital. When the media source data 902 is analog data, the media source data 902 may be converted to digital data using, for example, an analog-to-digital converter (ADC). Typically, to transmit the media source data 902, some type of compression and/or encryption may be desirable. Accordingly, an encoder 910 may be provided that may encode the media source data 902 using any encoding method in the art, known now or in the future, including encoding methods in accordance with coding standards such as, but not limited to, MPEG-2, MPEG-4, H.263, H.264, HEVC, or combinations of these or other encoding standards. The encoder 910 may be implemented with embodiments of the present invention described herein. For example, the encoder 910 may be implemented with the encoder 100 of FIG. 1 and/or the encoder 200 of FIG. 2.

The encoded data 912 may be provided to a communications link, such as a satellite 914, an antenna 916, and/or a network 918. The network 918 may be wired or wireless, and further may communicate using electrical and/or optical transmission. The antenna 916 may be a terrestrial antenna, and may, for example, receive and transmit conventional AM and FM signals, satellite signals, or other signals known in the art. The communications link may broadcast the encoded data 912, and in some examples may alter the encoded data 912 and broadcast the altered encoded data 912 (e.g. by re-encoding, adding to, or subtracting from the encoded data 912). The encoded data 920 provided from the communications link may be received by a receiver 922 that may include or be coupled to a decoder, such as the decoder 800 of FIG. 8. The decoder may decode the encoded data 920 to provide one or more media outputs, with the media output 904 shown in FIG. 9.

The receiver 922 may be included in or in communication with any number of devices, including but not limited to a modem, router, server, set-top box, laptop, desktop, computer, tablet, mobile phone, etc.

The media delivery system 900 of FIG. 9 and/or the encoder 910 may be utilized in a variety of segments of a content distribution industry.

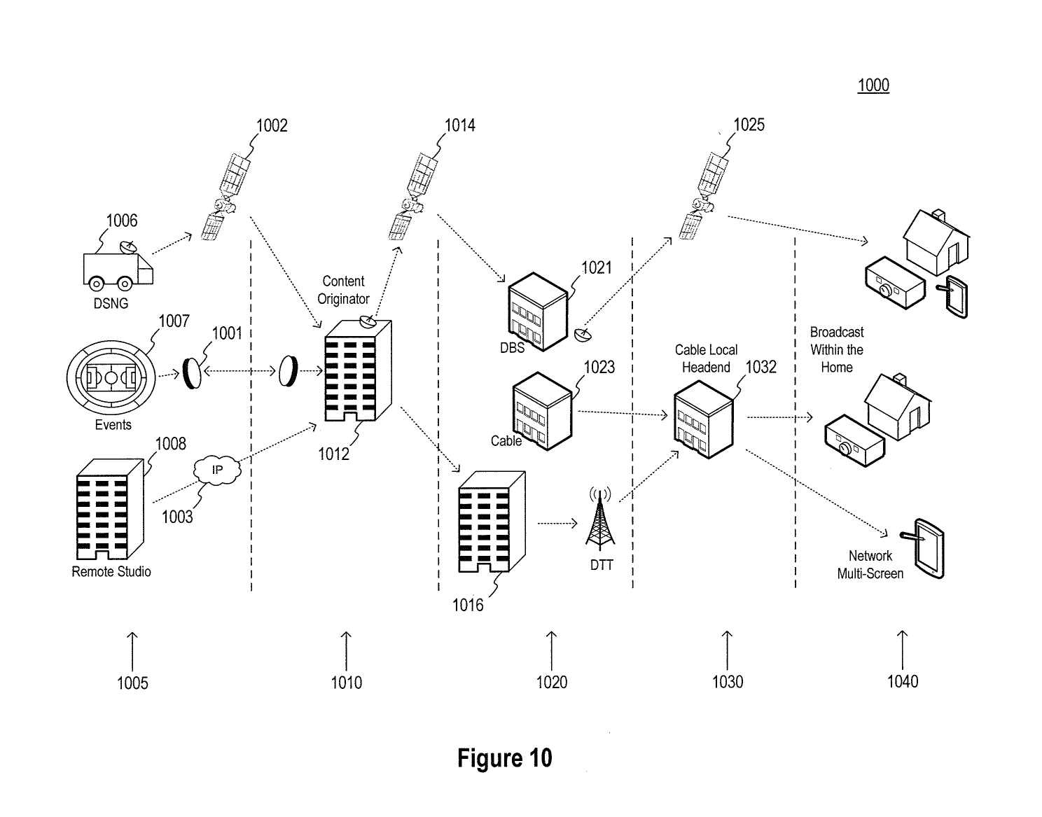

FIG. 10 is a schematic illustration of a video distribution system 1000 that may make use of encoders described herein. The video distribution system 1000 includes video contributors 1005. The video contributors 1005 may include, but are not limited to, digital satellite news gathering systems 1006, event broadcasts 1007, and remote studios 1008. Each or any of these video contributors 1005 may utilize an encoder described herein, such as the encoder 910 of FIG. 9, to encode media source data and provide encoded data to a communications link. The digital satellite newsgathering system 1006 may provide encoded data to a satellite 1002. The event broadcast 1007 may provide encoded data to an antenna 1001. The remote studio 1008 may provide encoded data over a network 1003.

A production segment 1010 may include a content originator 1012. The content originator 1012 may receive encoded data from any or combinations of the video contributors 1005. The content originator 1012 may make the received content available, and may edit, combine, and/or manipulate any of the received content to make the content available. The content originator 1012 may utilize encoders described herein, such as the encoder 100 of FIG. 1 or the encoder 200 of FIG. 2, to provide encoded data to the satellite 1014 (or another communications link). The content originator 1012 may provide encoded data to a digital terrestrial television system 1016 over a network or other communication link. In some examples, the content originator 1012 may utilize a decoder, such as the decoder 800 described with reference to FIG. 8, to decode the content received from the contributor(s) 1005. The content originator 1012 may then re-encode data and provide the encoded data to the satellite 1014. In other examples, the content originator 1012 may not decode the received data, and may utilize a transcoder to change an encoding format of the received data.

A primary distribution segment 1020 may include a digital broadcast system 1021, the digital terrestrial television system 1016, and/or a cable system 1023. The digital broadcasting system 1021 may include a receiver, such as the receiver 922 described with reference to FIG. 9, to receive encoded data from the satellite 1014. The digital terrestrial television system 1016 may include a receiver, such as the receiver 922 described with reference to FIG. 9, to receive encoded data from the content originator 1012. The cable system 1023 may host its own content, which may or may not have been received from the production segment 1010 and/or the contributor segment 1005. For example, the cable system 1023 may provide its own media source data 902 as that which was described with reference to FIG. 9.

The digital broadcast system 1021 may include an encoder, such as the encoder 910 described with reference to FIG. 9, to provide encoded data to the satellite 1025. The cable system 1023 may include an encoder, such as the encoder 100 of FIG. 1 or the encoder 200 of FIG. 2, to provide encoded data over a network or other communications link to a cable local headend 1032. A secondary distribution segment 1030 may include, for example, the satellite 1025 and/or the cable local headend 1032.

The cable local headend 1032 may include an encoder, such as the encoder 100 of FIG. 1 or the encoder 200 of FIG. 2, to provide encoded data to clients in a client segment 940 over a network or other communications link. The satellite 1025 may broadcast signals to clients in the client segment 1040. The client segment 1040 may include any number of devices that may include receivers, such as the receiver 922 and associated decoder described with reference to FIG. 9, for decoding content, and ultimately, making content available to users. The client segment 1040 may include devices such as set-top boxes, tablets, computers, servers, laptops, desktops, cell phones, etc.

Accordingly, encoding and/or decoding may be utilized at any of a number of points in a video distribution system. Embodiments of the present invention may find use within any, or in some examples all, of these segments.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. An apparatus comprising:
an encoder configured to receive a video signal and selectively downsample a first component of the video signal in accordance with a first RRU coding mode and a second component of the video signal in accordance with a second RRU coding mode based, at least in part, on the respective types of the first and second components of the video signal.

2. The apparatus of claim 1, wherein the encoder is further configured to selectively downsample the first and second components at a sequence level, a frame level, a macroblock level, or any combination thereof.

3. The apparatus of claim 1, wherein the encoder is further configured to perform motion prediction using full resolution references.

4. The apparatus of claim 1, wherein the encoder is further configured to selectively downsample the first component of the video signal based, at least in part, on a spatio-temporal analysis of the first component of the video signal.

5. An apparatus, comprising:
a decoder configured to receive an encoded bitstream and provide a recovered residual based, at least in part, on the encoded bitstream, the decoder further configured to selectively upsample a first component of the recovered residual in accordance with a first RRU mode and to selectively upsample a second component of the recovered residual in accordance with a second RRU mode to provide a reconstructed video signal based, at least in part, on one or more signaling mechanisms of the encoded bitstream.

6. The apparatus of 5, wherein the decoder is further configured to selectively upsample the first and second components at a sequence level, a frame level, a macroblock level, or any combination thereof.

7. The apparatus of 5, wherein the first and second components each comprise a red-difference chrominance component, a blue-difference chrominance component, a luminance component, or a combination thereof.

8. An encoder, comprising:
a mode decision block configured to receive a video signal and provide a signal in the video signal corresponding to a component of the video signal, the signal including an RRU coding mode; and
an entropy encoder coupled to the mode decision block and configured to receive the signal, the entropy encoder further configured to provide an encoded bitstream based, at least in part, on the component and the signal.

9. The encoder of claim 8, further comprising:
a downsampler coupled to the mode decision block and configured to downsample the component of the video signal in accordance with the RRU coding mode.

10. The encoder of claim 9, wherein the downsampler is further configured to downsample the residual based, at least in part, on an upsampling scheme.

11. The encoder of claim 8, wherein the component comprises a luminance component and the RRU coding mode corresponds to a full resolution.

12. A method of encoding, comprising:
receiving a video signal;
analyzing the video signal while operating in an RRU mode; and
after analyzing the video signal, selectively downsampling a component of the video signal based, at least in part, on a type of the component of the video signal.

13. The method of claim 12, wherein said analyzing the video signal in an RRU mode comprises:
performing spatio-temporal analysis on each of a plurality of regions.

14. The method of claim 12, wherein the component comprises a red-difference chrominance component, a blue-difference chrominance component, a luminance component, or a combination thereof.

15. The method of claim 12, wherein said selectively downsampling a component of the video signal comprises:
selectively downsampling a first component of the video signal in accordance with a first RRU coding mode; and
selectively downsampling a second component of the video signal in accordance with a second RRU coding mode.

16. The method of claim 12, wherein said selectively downsampling a component of the video signal comprises:
downsampling the component based, at least in part, on a normative upsampling scheme.

17. A method, comprising:
receiving, with a decoder, an encoded bitstream including a signaling mechanism indicative of an RRU type;
generating a residual based, at least in part, on the encoded bitstream; and
selectively upsampling a component of the residual based, at least in part, on the signaling mechanism.

18. The method of 17, wherein said selectively upsampling a component of the residual comprises:
selectively upsampling the component at a sequence level, a frame level, a macroblock level, or any combination thereof.

19. A method, comprising:
analyzing a sequence to determine whether a sequence level reduced resolution update mode is enabled;
if the sequence level reduced resolution update mode is enabled, analyzing a frame of the sequence to determine if a frame level reduced resolution update mode is enabled; and
if the frame level reduced resolution update mode is enabled, analyzing a macroblock of the frame to determine whether to downsample a component of a macroblock based, at least in part, on a type of the component.

20. The method of claim 19, further comprising:
after said analyzing a macroblock, providing an RRU coding mode corresponding to the component of the macroblock.

21. The method of claim 19, further comprising:
if the sequence level reduced resolution update mode is not enabled, encoding the sequence at full resolution; and
if the frame level reduced resolution update mode is not enabled, encoding the frame at full resolution.

22. A method, comprising:
performing spatio-temporal analysis on a macroblock;
generating preliminary reduced resolution update coding decisions based, at least in part, on said performing spatio-temporal analysis;
encoding a block of the macroblock using the preliminary reduced resolution update coding decisions;
determining if the encoded block satisfies a criterion; and
if the encoded block does not satisfy the criterion, encoding the block using fallback reduced resolution update decisions.

23. The method of claim 22, wherein said encoding a block of the macroblock using the preliminary reduced resolution update coding decisions comprises:
coding the block at a first resolution; and
wherein said if the encoded block does not satisfy the criterion, coding the block using fallback reduced resolution update decisions comprises:
coding the block at a second resolution, the second resolution being lower than the first resolution.

24. The method of claim 22, further comprising:
before said generating preliminary reduced resolution update decisions, partitioning the macroblock into blocks.
